(19) United States
(12) Patent Application Publication
(10) Pub. No.: US 2002/0112352 A1
(43) Pub. Date: Aug. 22, 2002

(54) ERGONOMIC SCISSORS

(76) Inventor: Michel Droin, Thorins (FR)

Correspondence Address: SCHWEITZER CORNMAN GROSS & BONDELL LLP, 19th Floor, 292 Madison Avenue, New York, NY, 10017, US

(21) Appl. No.: 09/785,797

(22) Filed: Feb. 16, 2001

(51) Int. Cl. B26B 13/12

(52) U.S. Cl. 30/254; 30/261; 30/262; 30/298

(57) ABSTRACT

In these scissors (1), one of the branches (2) entails a resting part (7) for the four fingers of the hand excluding the thumb, while the other branch (3) entails a resting part (8) for the thumb. The resting part (7) shows an exterior lateral face (7a) to rest the fingers upon and is joined to a hook (10) whose concave face (10a) outlines, with said lateral face (7a), a housing (11) which can narrowly receive the third or fourth finger of the operator, and whose convex face (10b) allows, at the level of the base of hook (10), a tightening of said hook (10) between the finger engaged in the housing (11) and the adjacent finger, the resting part (8) shows an exterior lateral face (8a) aimed at accommodating the thumb; the scissors (1) entail at least one elastic device (20) located between the two internal lateral faces of these two resting parts (7&8) allowing the maintenance of the branches (2&3) in a spread-apart position.

The present invention refers to ergonomic scissors.

In most cases, scissors have two rings provided on the side opposite to the blades, through these rings the user engages the thumb and the third or index finger, to hold and operate the scissor.

Such scissors are however not very easy to use for such persons as children or the handicapped and scissors whose rings are meant for someone right-handed are not easy to use for someone left-handed and vice-versa.

Furthermore, such standard scissors are not practical when used by hairdressers. In fact, a beautician must remove his or her thumb from the ring in order to grab another tool, then re-engage his or her thumb into the ring to use the scissors again. These movements may have to be repeated many times throughout the day; they are tiring, and at times, painful.

The present invention aims to remedy all of these inconveniences.

To that effect, in these scissors, one of the branches entails a rest embossment for the four fingers excluding the thumb, whereas the other branch entails a rest embossment for the thumb. The rest embossment for the four fingers presents an exterior, lateral face to rest these fingers upon, and is joined to a hook, curved in the direction opposite the blade. This lateral, concave face outlines, along with the lateral face of the rest embossment, a housing in which the third or the ring fingers of the user. The convex face allows, at the level of the base of that hook, a tightening of the hook between the engaged finger and the adjacent finger. The rest embossment for the thumb presents an exterior lateral face aimed to hold the thumb and is widened in a plane perpendicular to the plane of blades' movement. Furthermore, the scissors entail at least one elastic device located between the internal and lateral faces of the rest embossments. This device tends to normally maintain the scissors in a position of mutual separation.

The hook allows a hold of the scissors only by the positioning of the third or fourth finger in the housing outline by said hook and by tightening the base of the hook between the engaged and the adjacent fingers. The thumb therefore has no role in the grip of the scissors and is there only to activate the scissors against the reactive force of the elastic device. As a result, the thumb is free in relation to the scissors and can be used to grasp any other tool with the help of the index and third fingers, such as a comb in the case of a beautician, without having to engage or disengage the thumb from corresponding ring. All fingers but the thumb also allow, jointly with the thumb, through their ample resting surface against said embossment to perfectly direct the scissors while cutting. Furthermore, a left-handed as well as a right-handed person may use the scissors, according to this invention, in the same way, and comfortably.

Preferably, at least one of the rest embossments has, at the level of its extremity closest to the blade, one curved end which is laterally oriented relative to the longitudinal axis of the scissors and towards its exterior, the concave face of this extremity, being united in a continuous manner to the aforementioned rest embossment.

This extremity forms a ledge for the side of the index finger for the rest embossment of the four fingers, or, for the tip of the thumb for the rest area of the thumb. These ledges allow a firm longitudinal grip of the scissors and a good control of the direction when cutting. Said curved extremity and/or the concave face may be shaped in such a way to achieve the best orientation of the thumb when the user grasps the scissors.

Suitably, the rest embossment for the four fingers entails a curved end, such as previously described, and the distance separating said hook and the curved extremity corresponds approximately to the width of the fingers positioned between the hook and this extremity.

The convex face of the hook, the lateral face where the fingers rest and the concave face of said curved extremity outline thereby a space strictly adapted to receive one or more fingers, this increases the reliability of the grip of the scissors and the ease of its manipulation.

The rest embossment for the thumb may present, in the farthest portion relative to the blades, an inflexion towards the exterior of the scissors.

The lateral face of this portion spouses thereby the shape of the thumb and increases, in a longitudinal direction, the pressure surface of the thumb against this rest area. The grip and the control of the scissors are further enhanced.

With the same goal, the rest embossment for the four fingers may present, in its farthest portion relative to the blades, a similar inflexion towards the exterior of the scissors.

Suitably, the scissors entail two helicoidal and conical springs that are both attached to the branches by their smaller extremities. These two springs coming into contact, by their larger extremities, when closing the scissors.

These two springs constitute thereby the elastic device and allow a perfect return to their open position.

For better comprehension, the invention is again described hereunder and refers to the schematic drawings thereto attached, including, as an example of a preferred embodiment of the scissors.

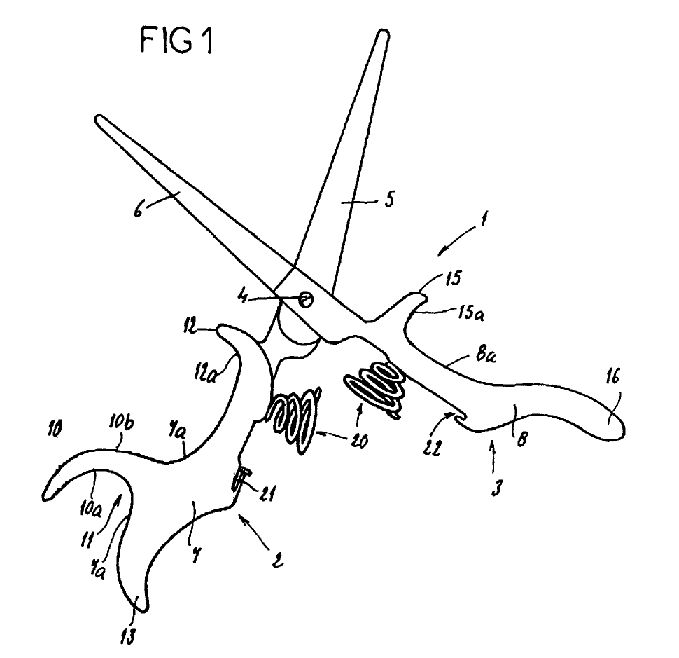

FIG. 1 is an elevation view of the scissors.

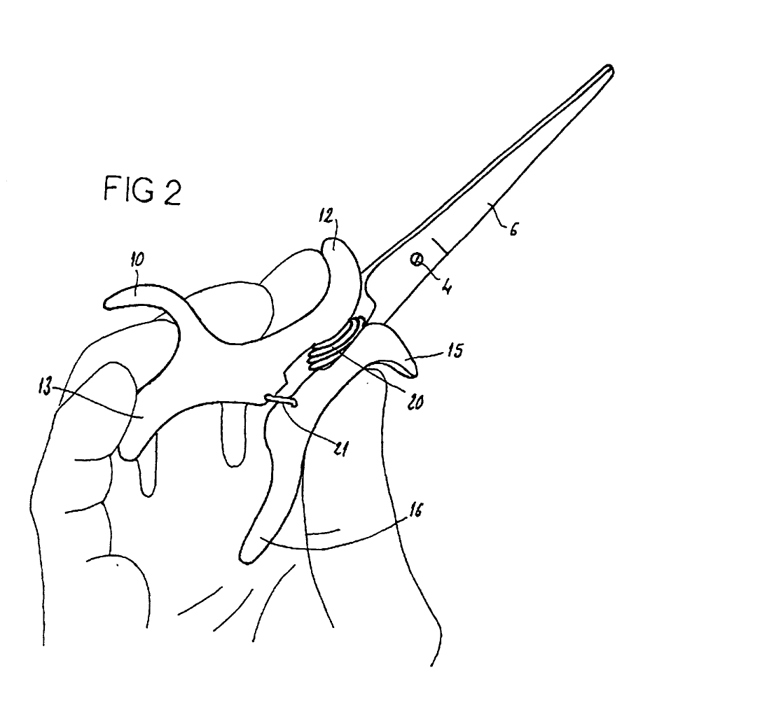

FIG. 2 is a view of the scissors when used by a right-handed person.

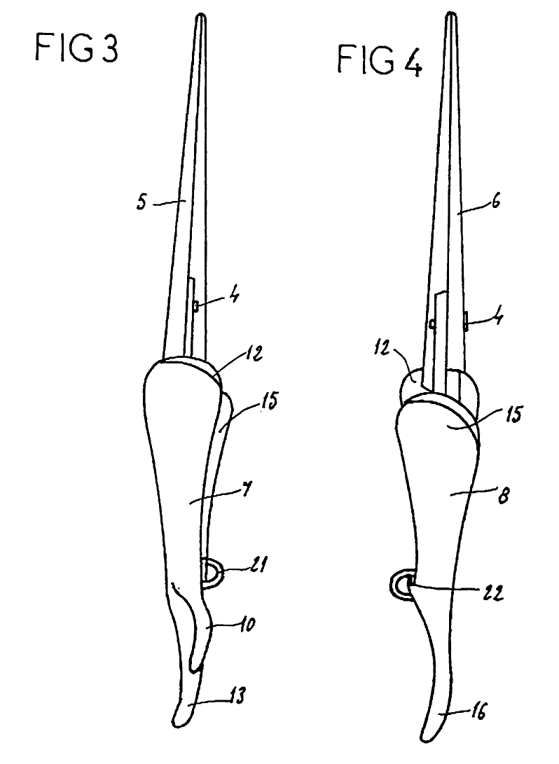

FIG. 3 is a side view of the scissors.

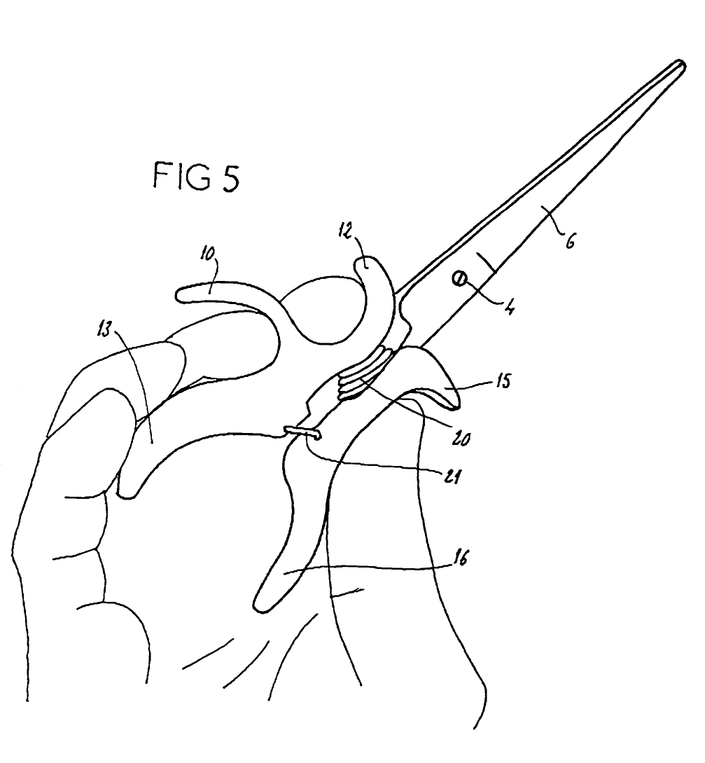

FIG. 4 is a view from the opposite side.

FIG. 5 is similar to FIG. 2, but in a different embodiment.

These figures represent ergonomic scissors (1) including two branches (2&3) pivoting relatively to one another around an axis (4).

Each branch (2&3) includes a blade (5&6) and a rest embossment (7&8), these parts (7&8) allow the grip and use of the scissors (1).

As shown in FIGS. 2 and 5, the scissors (2) include a rest embossment (7) for the four fingers (thumb excluded) whereas the scissors (3) include a rest embossment (8) for the thumb.

Part (7) presents an exterior lateral face (7a) to rest the four fingers which is linked to a hook (10), curved in direction opposite the blade (5). The concave lateral face (10a) of hook (10) outlines with face (7a) a housing (11) that can receive either the ring finger of the operator in the embodiment of the scissors (1) as shown in FIGS. 1 through 4, or, the third finger of the operator in the version show in FIG. 5. The convex face (10b) of the hook (10) allows, at the level of the base of this hook (10), a tightening of hook (10) between the finger in the housing (11) and the adjacent finger.

Part (7) equally presents, at the level of its extremity close to the blade (5), a curved end (12) laterally oriented relative to the longitudinal axis of scissors (2) and towards its exterior. The concave face (12a) of this extremity is bent towards face (12b) and is contiguous to face (7a).

The distance that separates hook (10) from extremity (12) corresponds roughly to the width of the finger (or fingers) meant to rest between this hook (10) and this extremity (12) as shown in FIGS. 2 and 5.

Furthermore, part (7) shows its portion (13), farthest from blade (5), forming an inflexion towards the outside of the scissors (1), in such a way that face (7a) is shifted towards the exterior at the level of said portion (13).

Part (8) presents an exterior lateral face (8a) aimed to support the thumb; this portion is widened in a plane perpendicular to the plane of the opening of the scissors (2&3) relative to one another.

This part (8) entails an extremity (15) close to the blade (6), which is curved and which is laterally oriented in relation to the longitudinal axis of the scissors (3) and its exterior. The concave face (15a) of this extremity (15) is connected in a contiguous way to face (8a). It appears in FIGS. 3 and 4 that (5) is slightly shifted in relation to part (12) in the plane in which the scissors (2) and (3) pivot to allow a better grasp.

Part (8) also shows a portion (16) farthest from blade (6) that has an inflected shape towards the exterior in such a way that said portion (16) is suitably formed to wrap around the thumb as shown in FIGS. 2 and 3.

Furthermore, the scissors (1) entail two helicoidal springs shaped as cones each of which is attached to parts (7&8) by its smallest extremity at the level of the internal lateral face of these parts (7&8).

It appears these figures that these two springs (20) come to rest upon one another as branches (2&3) come together by their greatest extremities and thereby tend to normally maintain branches (2&3) in a spread-apart position.

Scissors (1) also entail a hook (21) mounted on part (7) and a notch (22) provided in part (8) to house hook (21). This engagement allows the maintenance of branches (2&3) in a closed position when not in use. As shown in FIGS. 3 and 4, this hook (21) is round-shaped to be disengaged from notch (22) with the thumb of the hand holding the scissor (1), then to be secured on part (7) in order to keep the scissors in an open position.

The invention gives ergonomic scissors, which remedy the inconvenience common to most prior-art scissors. In fact, the hook (10) allows a grasp of the scissors (1) solely by the engagement of the third or fourth finger in the housing (11) and by the tightening of the base of hook (10) between the finger engaged in housing (11) and the adjacent finger. The hook (10) allows the pivoting of the scissors in an open position farther than the action of the springs (20). The thumb has therefore no role in the grasp of the scissors (1); it only comes to rest against the corresponding face (8a) of part (8) to activate the branches (2&3) and to also help the opening of the scissors farther than the action of springs (20).

The broad rest area of the four fingers, excluding the thumb, against part (7), the ledges shaped by the extremities (12&15), and the shape of portions (14&16) allow a perfect grasp and control of direction of the scissors (1) when cutting.

These scissors (1) can also be used in a similar way and with similar comfort by a left-handed or right-handed person.

1. Ergonomic scissors characterized by the fact that one branch (2) entails a resting part (4) for four fingers, excluding the thumb, while the other branch (3) entails a rest part (8) for the thumb; the resting pat (7) for the four fingers shows an exterior lateral face (7a) to rest these fingers upon and is joined to a hook (10) curved towards the side opposite the blade (5) of branch (2) of which the concave lateral face (10a) outlines, with said lateral face (7a) of the resting part (7), a housing (11) in which can be tightly placed the third or fourth finger of the operator and which convex face (10b) allows, at the level of the base of the hook, a tightening of the hook (10) between the finger engaged in the housing (11) and the adjacent finger; the resting part (8) for the thumb shows an exterior lateral face (8a) meant to accommodate the thumb, this part is widened in a plane perpendicular to the plane of the opening of the branches (2&3) one relative to another; the scissors (1) entail at least one elastic device (20) located between the two lateral faces of the two resting parts (7&8) which tend to normally maintain the branches (2&3) in a spread-apart position.

2. Scissors according to claim 1 characterized by the fact that at least one of the resting parts (7&8) shows at the level of its extremity closest to the blades (5&6) of branches (2&3), a curved extremity (12&15) laterally oriented relative to the longitudinal axis of branches (2&3) and towards its exterior, the concave face (12a&15a) of this extremity (12&15) being contiguous to the lateral face (7a&8a) of the resting parts (7&8).

3. Scissors, according to claim 2, characterized by the fact that resting part (7) for the four fingers, excluding the thumb, includes a curved extremity (12) as previously said, and by the fact that the distance between the hook (10) of this curved extremity (12) corresponds roughly to the width of the finger or fingers to be placed between this hook (10) and this extremity (12).

4. Scissors, according to claims 1 through 3, characterized by the fact that resting part (8) for the thumb shows a portion (16) farthest from the blade (6) of branch (3) which shows an inflexion towards the exterior of branch (3).

5. Scissors, according to claim 1 through 4, characterized by the fact that the resting part (7) for the four fingers, excluding the thumb shows a portion (13) farthest from blade (5) of branch (2) forming an inflexion towards the exterior of branch (2).

6. Scissors, according to claims 1 through 5, characterized by the fact that they entail two helicoidal springs (20) shaped as cones, each of which is attached to the resting parts (7&8) by theirs smallest extremities, these two springs (20) coming into contact by their wider extremities.
